(19) United States
(12) Patent Application Publication
(10) Pub. No.: US 2012/0264672 A1
(43) Pub. Date: Oct. 18, 2012

(54) MACHINE CLEANING METHOD

(75) Inventors: Thorsten Bastigkeit, Wuppertal (DE); Johannes Zipfel, Dusseldorf (DE); Arnd Kessler, Monheim am Rhein (DE); Thomas Eiting, Dusseldorf (DE); Christian Nitsch, Dusseldorf (DE); Dorota Sendor-Müller, Dusseldorf (DE); Konstantin Benda, Dusseldorf (DE)

(73) Assignee: Henkel AG & Co. KGaA, Dusseldorf (DE)

(21) Appl. No.: 13/457,184

(22) Filed: Apr. 26, 2012

Related U.S. Application Data
(63) Continuation of application No. PCT/EP2010/066417, filed on Oct. 29, 2010.

(30) Foreign Application Priority Data
Oct. 30, 2009 (DE) 10 2009 046 240.6

(51) Int. Cl. C11D 17/00; B08B 3/08; D06L 1/20

(52) U.S. Cl. 510/406; 8/137; 134/25.2

(57) ABSTRACT

An automatic dishwashing method using a bleaching-agent-free cleaning-agent presentation form comprising a plurality liquid cleaning agent preparations being dispensed into the interior of an automatic dishwasher, in the course of the cleaning method, from a cartridge located preferably in the interior of the cleaning machine, wherein a sub-quantity of each of the cleaning-agent preparation located in the cartridge is dispensed into the interior of the cleaning machine, a residual quantity of each of the cleaning-agent preparations located in the cartridge remaining in the cartridge until the end of the cleaning method, and said residual quantity corresponding to at least twice the quantity of the sub-quantity dispensed.

### CROSS-REFERENCES TO RELATED APPLICATIONS

This application is a continuation of PCT/EP2010/066417, filed on Oct. 29, 2010, which claims priority under 35 U.S.C. §119 to DE 10 2009 046 240.6 filed on Oct. 30, 2009, both of which are hereby incorporated by reference.

### FIELD OF THE INVENTION

The present invention generally relates to automatic cleaning methods, and more particularly relates to automatic cleaning methods using bleaching agent-free cleaning agents.

### BACKGROUND OF THE INVENTION

The demands made on the packaging and presentation forms of washing and cleaning agents are continually changing. For some time, emphasis has been placed principally on convenient dispensing of washing and cleaning agents by the consumer, and on simplifying the working steps necessary for carrying out a washing or cleaning method.

In this connection, dispensing systems for multiple dispensing of washing and cleaning agents have very recently come under scrutiny by product developers. With regard to these apparatuses, a distinction may be made between on the one hand dispensing systems integrated into the automatic dishwasher or textile washing machine, and on the other hand movable dispensing systems independent of the automatic dishwasher or textile washing machine. By means of these dispensing systems, which contain several times the quantity of cleaning agent required to carry out a cleaning method, washing- or cleaning-agent portions are automatically or semi-automatically dispensed into the interior of the cleaning machine in the course of multiple successive cleaning methods. For the consumer, the need for repeated manual dispensing of the washing and cleaning agents is eliminated. Examples of such apparatuses are described in European patent applications EP 1 759 624 A2 (Reckitt Benckiser) and EP 1 976 970 A1 (Reckitt Benckiser) or in German patent application DE 10 5005 062 479 A1 (BSH Bosch und Siemens Hausgeräte GmbH).

Regardless of the exact construction of the dispensing systems used in the interior of automatic dishwashers or textile washing machines, the washing or cleaning agents contained in these apparatuses for multiple dispensing are exposed over a longer period of time to, in particular, alternating temperatures, these temperatures being equal approximately to the water temperatures used to carry out the washing or cleaning method. These temperatures can be equal to up to 95° C., temperatures of only between 50 and 75° C. usually being reached in the sector of automatic dishwashing. A washing or cleaning agent contained in a dispensing system provided for multiple dispensing is thus repeatedly heated, in the course of multiple washing or cleaning methods, to temperatures well above the temperatures usual for transport and for storage, temperature-sensitive active substances also being affected in particular. Included in the group of these temperature-sensitive substances having washing and cleaning activity are, for example, the enzymes.

Accordingly, it is desirable to make available an automatic dishwashing method or textile washing method in which a chemically and physically stable cleaning-agent preparation is dispensed, by means of a reservoir apparatus located by preference in the interior of an automatic dishwasher resp. textile washing machine, over multiple cleaning cycles. The cleaning-agent preparation was intended in this context to be capable of storage in the reservoir apparatus for the duration of multiple cleaning methods without significant loss of activity, and to possess good cleaning and rinsing properties.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

An automatic dishwashing method using a bleaching-agent-free cleaning-agent presentation form comprising a preferably liquid cleaning-agent preparation A having a pH (10% solution in H₂O; 20° C.) above 8.0, containing at least one builder; a preferably liquid cleaning-agent preparation B containing at least one enzyme preparation; and a preferably liquid cleaning-agent preparation C containing at least one nonionic surfactant and/or one acid, the cleaning-agent preparations A, B, and C being dispensed into the interior of the automatic dishwasher, in the course of the dishwashing method, from a cartridge located preferably in the interior of the automatic dishwasher, wherein a sub-quantity a of the cleaning-agent preparation A located in the cartridge is dispensed into the interior of the automatic dishwasher, a residual quantity of the cleaning-agent preparation A located in the cartridge remaining in the cartridge until the end of the dishwashing method, and said residual quantity corresponding to at least twice, by preference at least four times, and in particular at least eight times the quantity of sub-quantity a; and a sub-quantity b of the cleaning-agent preparation B located in the cartridge is dispensed into the interior of the automatic dishwasher, a residual quantity of the cleaning-agent preparation B located in the cartridge remaining in the cartridge until the end of the dishwashing method, and said residual quantity corresponding to at least twice, by preference at least four times, and in particular at least eight times the quantity of sub-quantity b; and a sub-quantity c of the cleaning-agent preparation C located in the cartridge is dispensed into the interior of the automatic dishwasher, a residual quantity of the cleaning-agent preparation C located in the cartridge remaining in the cartridge until the end of the dishwashing method, and said residual quantity corresponding to at least twice, by preference at least four times, and in particular at least eight times the quantity of sub-quantity c.

An automatic textile washing method using a bleaching-agent-free cleaning-agent presentation form comprising a preferably liquid cleaning-agent preparation A having a pH (10% solution in H₂O; 20° C.) above 8.0, containing at least one builder; a preferably liquid cleaning-agent preparation B containing at least one enzyme preparation; and a preferably liquid cleaning-agent preparation C containing at least one compound selected from textile conditioning agents, defoamers, complexing agents, and perfume substances, the cleaning-agent preparations A, B, and C being dispensed into the interior of the textile washing machine, in the course of the textile washing method, from a cartridge located preferably in the interior of the textile washing machine, wherein a sub-quantity a of the cleaning-agent preparation A located in the cartridge is dispensed into the interior of the textile washing machine, a residual quantity of the cleaning-agent preparation A located in the cartridge remaining in the cartridge until the end of the textile washing method, and said residual quantity corresponding to at least twice, by preference at least four times, and in particular at least eight times the quantity of sub-quantity a; and a sub-quantity b of the cleaning-agent preparation B located in the cartridge is dispensed into the interior of the textile washing machine, a residual quantity of the cleaning-agent preparation B located in the cartridge remaining in the cartridge until the end of the textile washing method, and said residual quantity corresponding to at least twice, by preference at least four times, and in particular at least eight times the quantity of sub-quantity b; a sub-quantity c of the cleaning-agent preparation C located in the cartridge is dispensed into the interior of the textile washing machine, a residual quantity of the cleaning-agent preparation C located in the cartridge remaining in the cartridge until the end of the textile washing method, and said residual quantity corresponding to at least twice, by preference at least four times, and in particular at least eight times the quantity of sub-quantity c.

A cleaning-agent presentation form comprising a preferably liquid cleaning-agent preparation A having a pH (10% solution in H₂O; 20° C.) above 8.0, containing at least one builder; a preferably liquid cleaning-agent preparation B containing at least one enzyme preparation; and a preferably liquid cleaning-agent preparation C containing at least one nonionic surfactant and/or one acid, wherein the cleaning-agent preparations A, B, and C are present separately from one another in one common cartridge.

A cleaning-agent presentation form comprising a preferably liquid cleaning-agent preparation A having a pH (10% solution in H₂O; 20° C.) above 8.0, containing at least one builder; a preferably liquid cleaning-agent preparation B containing at least one enzyme preparation; and a preferably liquid cleaning-agent preparation C containing at least one compound selected from textile conditioning agents, defoamers, complexing agents, and perfume substances, wherein the cleaning-agent preparations A, B, and C are present separately from one another in one common cartridge.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

A first subject of the present Application is an automatic dishwashing method using a bleaching agent-free cleaning-agent presentation form encompassing
a) a preferably liquid cleaning-agent preparation A having a pH (10% solution in H₂O; 20° C.) above 8.0, containing at least one builder;
b) a preferably liquid cleaning-agent preparation B containing at least one enzyme preparation;
c) a preferably liquid cleaning-agent preparation C containing at least one nonionic surfactant and/or one acid,
   the cleaning-agent preparations A, B, and C being dispensed into the interior of the automatic dishwasher, in the course of the dishwashing method, from a cartridge located preferably in the interior of the automatic dishwasher, wherein
   i) a sub-quantity a of the cleaning-agent preparation A located in the cartridge is dispensed into the interior of the automatic dishwasher, a residual quantity of the cleaning-agent preparation A located in the cartridge remaining in the cartridge until the end of the dishwashing method, and said residual quantity corresponding to at least twice, by preference at least four times, and in particular at least eight times the quantity of sub-quantity a; and
   ii) a sub-quantity b of the cleaning-agent preparation B located in the cartridge is dispensed into the interior of the automatic dishwasher, a residual quantity of the cleaning-agent preparation B located in the cartridge remaining in the cartridge until the end of the dishwashing method, and said residual quantity corresponding to at least twice, by preference at least four times, and in particular at least eight times the quantity of sub-quantity b; and
   iii) a sub-quantity c of the cleaning-agent preparation C located in the cartridge is dispensed into the interior of the automatic dishwasher, a residual quantity of the cleaning-agent preparation C located in the cartridge remaining in the cartridge until the end of the dishwashing method, and said residual quantity corresponding to at least twice, by preference at least four times, and in particular at least eight times the quantity of sub-quantity c.

A further subject of the present Application is an automatic textile washing method using a bleaching-agent-free cleaning-agent presentation form encompassing
a) a preferably liquid cleaning-agent preparation A having a pH (10% solution in H₂O; 20° C.) above 8.0, containing at least one builder;
b) a preferably liquid cleaning-agent preparation B containing at least one enzyme preparation;
c) a preferably liquid cleaning-agent preparation C containing at least one compound selected from textile conditioning agents, defoamers, complexing agents, and perfume substances,
   the cleaning-agent preparations A, B, and C being dispensed into the interior of the textile washing machine, in the course of the textile washing method, from a cartridge located preferably in the interior of the textile washing machine, wherein
   i) a sub-quantity a of the cleaning-agent preparation A located in the cartridge is dispensed into the interior of the textile washing machine, a residual quantity of the cleaning-agent preparation A located in the cartridge remaining in the cartridge until the end of the textile washing method, and said residual quantity corresponding to at least twice, by preference at least four times, and in particular at least eight times the quantity of sub-quantity a; and
   ii) a sub-quantity b of the cleaning-agent preparation B located in the cartridge is dispensed into the interior of the textile washing machine, a residual quantity of the cleaning-agent preparation B located in the cartridge remaining in the cartridge until the end of the textile washing method, and said residual quantity corresponding to at least twice, by preference at least four times, and in particular at least eight times the quantity of sub-quantity b; and
   iii) a sub-quantity c of the cleaning-agent preparation C located in the cartridge is dispensed into the interior of the textile washing machine, a residual quantity of the cleaning-agent preparation C located in the cartridge remaining in the cartridge until the end of the textile washing method, and said residual quantity corresponding to at least twice, by preference at least four times, and in particular at least eight times the quantity of sub-quantity c.

The cleaning-agent presentation form according to the present invention encompasses the three cleaning-agent preparations A, B, and C. These cleaning-agent preparations are separated from one another and are present by preference in one common cartridge. Automatic dishwashing methods and automatic textile washing methods according to the present invention, wherein the cleaning-agent preparations A, B, and C are present separately from one another in one common cartridge, are preferred. Combined packaging of the cleaning-agent preparations in one common cartridge simplifies the manufacture and handling of the cleaning-agent preparation. If the cleaning-agent preparations A, B, and C are packaged in the common cartridge in such a way that the cleaning-agent preparations A, B, and C separated from one another are adjacent to one another, i.e. the receiving chambers used for packaging of the cleaning-agent preparations A, B, and C have at least one common wall, then packaging of the cleaning-agent preparations in one common cartridge is furthermore suitable for enhancing the chemical and physical stability of said cleaning-agent preparations and reducing the disadvantageous effect of the temperature fluctuations that necessarily occur.

A cleaning-agent presentation form encompassing
a) a preferably liquid cleaning-agent preparation A having a pH (10% solution in H₂O; 20° C.) above 8.0, containing at least one builder;
b) a preferably liquid cleaning-agent preparation B containing at least one enzyme preparation;
c) a preferably liquid cleaning-agent preparation C containing at least one nonionic surfactant and/or one acid,
   wherein the cleaning-agent preparations A, B, and C are present separately from one another in one common cartridge, is a further subject of the present invention.

A further subject of the present invention is also a cleaning-agent presentation form encompassing
a) a preferably liquid cleaning-agent preparation A having a pH (10% solution in H₂O; 20° C.) above 8.0, containing at least one builder;
b) a preferably liquid cleaning-agent preparation B containing at least one enzyme preparation;
c) a preferably liquid cleaning-agent preparation C containing at least one compound selected from textile conditioning agents, defoamers, complexing agents, and perfume substances,
   wherein the cleaning-agent preparations A, B, and C are present separately from one another in one common cartridge.

The methods according to the present invention are used in particular for repeated dispensing of cleaning-agent preparations from reservoir containers located in the interior of the automatic dishwasher resp. textile washing machine. Preferred methods according to the present invention are characterized in that a sub-quantity of the preferably liquid cleaning-agent preparations A, B, and C remains, before dispensing thereof into the interior of the automatic dishwasher resp. textile washing machine, in the reservoir container located in the automatic dishwasher resp. textile washing machine for the duration of at least two, by preference at least four, particularly preferably at least eight, and in particular at least twelve separate cleaning methods.

A “separate cleaning method” refers, in the context of the present Application, to self-contained cleaning methods that, besides the main cleaning cycle, by preference furthermore encompass a pre-wash cycle and/or a rinse cycle resp. post-wash cycle, and that can be selected and initiated, for example, by means of the program switch of the automatic dishwasher resp. textile washing machine. The duration of these separate cleaning methods is equal to by preference at least 15 minutes, in particular between 20 and 360 minutes, preferably between 30 and 240 minutes.

The time span between two separate cleaning methods within which the liquid cleaning-agent preparation is dispensed into the interior of the automatic dishwasher resp. textile washing machine is by preference equal to at least 20 minutes, by preference at least 60 minutes, particularly preferably at least 120 minutes.

The cleaning-agent presentation form according to the present invention and the cleaning-agent preparations according to the present invention are notable for particular temperature stability. The temperature stress on the cleaning-agent preparations according to the present invention can fluctuate within wide limits in the course of the methods according to the present invention, the liquid cleaning-agent preparations being suitable in particular for those methods in which the preferably liquid cleaning-agent preparations A, B, and C in the reservoir container are heated at least twice, by preference at least four times, particularly preferably at least eight times, and in particular at least twelve times to temperatures above 30° C., by preference above 40° C., and particularly preferably above 50° C. Heating to temperatures above 60° C. resp. above 70° C., resp. heating of the cleaning-agent preparation A twenty or thirty times, is likewise achievable according to the present invention.

In other words, the preferably liquid cleaning-agent preparations A, B, and C in the reservoir container are heated, by the washing bath surrounding said reservoir container, in each of the successively occurring separate cleaning methods. In preferred methods, the preferably liquid cleaning-agent preparations A, B, and C in the reservoir container furthermore cool, between the separate cleaning methods, to temperatures below 30° C., by preference below 26° C., and in particular below 22° C.

With reference to the cleaning effect of methods according to the present invention, dispensing of the two, three, or more cleaning-agent preparations at different points in time in the course of the dishwashing method resp. textile washing method has proven advantageous. It is particularly preferred in this context to dispense the cleaning-agent preparation B before the cleaning-agent preparations A and C into the interior (i.e. internal space) of the automatic dishwasher resp. textile washing machine. Automatic dishwashing methods resp. textile washing methods according to the present invention, wherein the cleaning-agent preparations A, B, and C are dispensed into the interior of the automatic dishwasher resp. textile washing machine at different points in time in the course of the dishwashing method resp. textile washing method, are preferred according to the present invention.

This Application further claims an automatic dishwashing method or automatic textile washing method using a cleaning-agent presentation form encompassing
a) a preferably liquid cleaning-agent preparation A having a pH (10% solution in H₂O; 20° C.) above 8.0, containing at least one builder;
b) a preferably liquid cleaning-agent preparation B containing at least one enzyme preparation;
c) a preferably liquid cleaning-agent preparation C containing at least one nonionic surfactant and/or one acid, and/or at least one compound selected from textile conditioning agents, defoamers, complexing agents, and perfume substances,
   the cleaning-agent preparations A, B, and C being dispensed into the interior of the automatic dishwasher resp. textile washing machine, in the course of the dishwashing method resp. textile washing method, from a cartridge located in the interior of the automatic dishwasher resp. textile washing machine, wherein
a) at a point in time t1, a sub-quantity a of the cleaning-agent preparation A located in the cartridge is dispensed into the interior of the automatic dishwasher resp. textile washing machine, a residual quantity of the cleaning-agent preparation A located in the cartridge remaining in the cartridge until the end of the dishwashing method resp. textile washing method, and said residual quantity corresponding to at least twice, by preference at least four times, and in particular at least eight times the quantity of sub-quantity a;
b) at at least one further point in time t2≠t1, a sub-quantity b of the cleaning-agent preparation B located in the cartridge is dispensed into the interior of the automatic dishwasher resp. textile washing machine, a residual quantity of the cleaning-agent preparation B located in the cartridge remaining in the cartridge until the end of the dishwashing method resp. textile washing method, and said residual quantity corresponding to at least twice, by preference at least four times, and in particular at least eight times the quantity of sub-quantity b;
c) at at least one further point in time t3≠t2≠t1, a sub-quantity c of the cleaning-agent preparation C located in the cartridge is dispensed into the interior of the automatic dishwasher resp. textile washing machine, a residual quantity of the cleaning-agent preparation C present in the cartridge remaining in the cartridge until the end of the dishwashing method resp. textile washing method, and said residual quantity corresponding to at least twice, by preference at least four times, and in particular at least eight times the quantity of sub-quantity c.

In preferred embodiments of the above-described automatic dishwashing methods and textile washing methods with time-offset dispensing of the cleaning-agent preparations A, B, and C, the point in time t1 is at least 1 minute, by preference at least 2 minutes, and in particular between 3 and 20 minutes after the point in time t2.

In a further preferred embodiment of the above-described automatic dishwashing methods and textile washing methods with time-offset dispensing of the cleaning-agent preparations A, B, and C, the point in time t3 is at least 1 minute, by preference at least 2 minutes, and in particular between 3 and 20 minutes after the point in time t2.

The cleaning-agent preparations used in the automatic dishwashing method and textile washing method according to the present invention are by preference liquid. These preparations contain by preference water as an essential solvent. The water content of the cleaning-agent preparation B is, based on its total weight, equal to by preference between 2 and 50 wt %, preferably between 4 and 40 wt %, and in particular between 5 and 35 wt %.

The addition of water to the cleaning-agent preparations A, B, and C does not merely facilitate dispensing thereof; in addition, the water content accelerates the release into the cleaning bath of the ingredients having cleaning activity.

The term “water content” encompasses the total quantity of water contained in the agents according to the present invention, which quantity is made up of the free water contained in the agents as well as the water incorporated into the cleaning-agent preparations in bound form via the active substances having washing and cleaning activity. The water content is to be determined, for example, as drying loss or by the Karl Fischer method.

The cleaning-agent preparations A used preferably according to the present invention contain builder as an essential constituent. The weight proportion of the builder in terms of the total weight of the cleaning-agent preparation A is equal to by preference to 60 wt %, particularly preferably 20 to 50 wt %.

As provided by the present Application, the group of the builders includes the organic complexing agents as well as the alkali carriers and the anionic polymers having cleaning activity. The high builder content (from 15 to 60 wt %) of cleaning-agent preparations A according to the present invention is distributed among these three groups of builders.

The group of the organic complexing agents includes in particular polycarboxylates/polycarboxylic acids, polymeric carboxylates, aspartic acid, polyacetals, dextrins, and further organic cobuilders such as the phosphonates. These substance classes are described below. Automatic dishwashing methods, wherein the cleaning-agent preparation A contains a complexing agent, by preference a complexing agent from the group of ethylenediaminedisuccinic acid and salts thereof, the phosphonates, and the polycarboxylates, are preferred according to the present invention.

Usable organic complexing agents are, for example, the polycarboxylic acids usable in the form of the free acid and/or their sodium salts, “polycarboxylic acids” being understood as those carboxylic acids that carry more than one acid function. These are, for example, citric acid, adipic acid, succinic acid, ethylenediaminedisuccinic acid, glutaric acid, malic acid, tartaric acid, maleic acid, fumaric acid, sugar acids, aminocarboxylic acids, nitrilotriacetic acid (NTA), provided such use is not objectionable for environmental reasons, as well as mixtures thereof. The free acids typically also possess, besides their builder effect, the property of an acidifying component, and thus also serve to establish a lower and milder pH for washing or cleaning agents. To be mentioned in this context are, in particular, citric acid, succinic acid, glutaric acid, adipic acid, gluconic acid, and any mixtures thereof.

Also to be mentioned as further preferred builder substances are polymeric aminodicarboxylic acids, salts thereof, or precursor substances thereof. Polyaspartic acids resp. salts thereof are particularly preferred.

Oxydisuccinates and other derivatives of disuccinates, by preference ethylenediamine disuccinate, are also additional suitable co-builders. Ethylenediamine-N,N′-disuccinate (EDDS) is used here, preferably in the form of its sodium or magnesium salts. Also preferred in this context are glycerol disuccinates and glycerol trisuccinates.

With particular preference, the cleaning-agent preparations A according to the present invention contain methylglycinediacetic acid or a salt of methylglycinediacetic acid.

Other usable organic complexing agents are, for example, acetylated hydroxycarboxylic acids resp. salts thereof, which can optionally also be present in lactone form and which contain at least 4 carbon atoms and at least one hydroxy group, as well as a maximum of two acid groups.

A second important organic complexing agent is ethylenediaminedisuccinic acid (EDDS), preferred cleaning-agent preparations A being characterized in that they contain, based on their total weight, 2.0 to 20 wt %, by preference 2.0 to 10 wt %, and in particular 2.0 to 8.0 wt % ethylenediaminedisuccinic acid. Ethylenediaminedisuccinic acid has proven to be particularly effective, in particular in phosphate-free cleaning-agent preparations, in terms of cleaning tea in the context of automatic dishwashing.

The term “ethylenediaminedisuccinic acid” (EDDS) encompasses not only the free acids but also salts thereof, for example sodium or potassium salts thereof. With regard to the weight proportion of ethylenediaminedisuccinic acid used in the agents according to the present invention; when the acid salt is used, the weight proportion of the free acid must be considered, i.e. the weight proportion of the salt must be converted to the weight proportion of the acid.

Alternatively or as a supplement to EDDS, the cleaning-agent preparations A according to the present invention can lastly contain methylglycinediacetic acid (MGDA). Methylglycinediacetic acid can be present in the agents according to the present invention in the form of the free acid, in partly neutralized or completely neutralized form. In a particularly preferred embodiment, methylglycinediacetic acid is present in the form of an alkali-metal salt.

Methylglycinediacetic acid can be replaced, in the automatic dishwashing agents according to the present invention, by other alkylglycinediacetic acids of the general formula MOOC—CHR—N(CH₂ COOM)₂ (R═H or C₂₋₁₂ alkyl; M, mutually independently, is H or alkali metal); methylglycinediacetic acid is, however, preferred for cost reasons.

The complexing phosphonates constitute a group of further organic complexing agents used with preference in the cleaning-agent preparations A according to the present invention, this group encompassing, besides 1-hydroxyethane-1,1-diphosphonic acid, a number of different compounds such as, for example, diethylenetriaminepenta(methylenephosphonic acid) (DTPMP). Hydroxyalkane- resp. aminoalkanephosphonates are particularly preferred in this Application. Among the hydroxyalkanephosphonates, 1-hydroxyethane-1,1-diphosphonate (HEDP) is of particular importance as a co-builder. It is used by preference as a sodium salt, the disodium salt reacting neutrally and the tetrasodium salt in alkaline fashion (pH 9). Suitable aminoalkanephosphonates are, by preference, ethylenediaminetetramethylenephosphonate (EDTMP), diethylenetriaminepentamethylenephosphonate (DTPMP), as well as higher homologs thereof. They are used by preference in the form of the neutrally reacting sodium salts, e.g. as a hexasodium salt of EDTMP resp. as a hepta- and octasodium salt of DTPMP. Of the class of the phosphonates, HEDP is preferably used as a builder. The aminoalkanephosphonates moreover possess a pronounced ability to bind heavy metals. It may accordingly be preferred, in particular if the agents also contain bleaches, to use aminoalkanephosphonates, in particular DTPMP, or mixtures of the aforesaid phosphonates.

Particularly preferably, 1-hydroxyethane-1,1-diphosphonic acid (HEDP) is used. The weight proportion of the phosphonates, by preference of HEDP, in terms of the total weight of cleaning-agent preparations A according to the present invention is equal to by preference 0.5 to 20 wt %, by preference 2.0 to 18 wt %, and in particular 4.0 to 14 wt %.

A second group of the builders is constituted by the alkali carriers. Included in the group of the alkali carriers are the carbonates and/or hydrogen carbonates, as well as the alkali-metal hydroxides. The group of the carbonates and hydrogen carbonates is combined in the context of this Application using the term “(hydrogen) carbonate”.

Preferred cleaning-agent preparations A contain, based on their total weight, 1.0 to 30 wt %, by preference 2.0 to 25 wt %, and in particular 5.0 to 20 wt % builder(s) from the group of the alkali carriers.

It is particularly preferred to use (hydrogen) carbonate(s), by preference alkali (hydrogen) carbonate(s), particularly preferably sodium (hydrogen) carbonate or potassium (hydrogen) carbonate, in quantities from 1.0 to 40 wt %, by preference 2.0 to 30 wt %, and in particular 4.0 to 15 wt %, based on the total weight of the cleaning-agent preparation A.

Preferred cleaning-agent preparations A according to the present invention contain alkali-metal hydroxide(s) in order to increase resp. adjust the alkalinity. The alkali-metal hydroxides are used in the cleaning agents by preference in quantities between 2.0 and 22 wt %, by preference between 4.0 and 20 wt %, and in particular between 8.0 and 18 wt %, based in each case on the total weight of the cleaning agent. With particular preference, the cleaning-agent preparations A according to the present invention contain potassium hydroxide.

The cleaning-agent preparations A, B, and C, in particular cleaning-agent preparation A, can contain further builders in addition to the builders described above. An example of corresponding builders is the phosphates, which can be used in the cleaning-agent preparations, in particular cleaning-agent preparation A, by preference in the form of the alkali-metal phosphates, with particular preference for pentasodium resp. pentapotassium triphosphate (sodium resp. potassium tripolyphosphate).

Phosphates particularly preferred according to the present invention are pentasodium triphosphate K₅P₃O₁₀ (sodium tripolyphosphate) as well as the corresponding potassium salt pentapotassium triphosphate K₅P₃O₁₀ (potassium tripolyphosphate).

Cleaning-agent preparations A, B, and C preferred according to the present invention contain less than 10 wt %, particularly preferably less than 5 wt %, and in particular less than 2 wt % phosphate. Phosphate-free cleaning-agent preparations A, B, and C are very particularly preferred according to the present invention. Those cleaning-agent preparations A, B, and C according to the present invention that contain less than 2 wt %, by preference less than 1 wt %, and in particular less than 0.5 wt % silicate are furthermore preferred. Lowering both the phosphate content and the silicate content has proven advantageous in terms of the stability of the automatic dishwashing agents according to the present invention.

The anionic polymers having cleaning activity constitute a third group of the builders contained by preference in the cleaning-agent preparations according to the present invention.

The anionic polymers having cleaning activity can comprise two, three, four, or more different monomer units. Besides the homo- and copolymeric polycarboxylates, the group of these polymers also encompasses, inter alia, the copolymeric polysulfonates, which comprise besides a monomer from the group of the unsaturated carboxylic acids at least one further monomer from the group of the unsaturated sulfonic acids.

The weight proportion of anionic polymers having cleaning activity in terms of the total weight of cleaning-agent preparations A according to the present invention is equal to by preference 1.0 to 30 wt %, by preference 2.0 to 25 wt %, and in particular 5.0 to 20 wt %.

The polymeric polycarboxylates constitute a first group of anionic polymers having cleaning activity. Examples of such polymers are the alkali-metal salts of polyacrylic acid or of polymethacrylic acid, for example those having a relative molecular weight from 500 to 70,000 g/mol.

Suitable anionic polymers are, in particular, polyacrylates that preferably have a molecular weight from 2000 to 20,000 g/mol. Of this group in turn, the short-chain polyacrylates, which have molecular weights from 2000 to 10,000 g/mol and particularly preferably from 3000 to 5000 g/mol, may be preferred because of their superior solubility.

Also suitable are copolymeric polycarboxylates, in particular those of acrylic acid with methacrylic acid and of acrylic acid or methacrylic acid with maleic acid. Copolymers of acrylic acid with maleic acid that contain 50 to 90 wt % acrylic acid and 50 to 10 wt % maleic acid have proven particularly suitable. Their relative molecular weight, based on free acids, is equal to in general 2000 to 70,000 g/mol, by preference 20,000 to 50,000 g/mol, and in particular 30,000 to 40,000 g/mol.

The concentration of (co)polymeric polycarboxylates in preferred automatic dishwashing agents and automatic textile washing agents is equal to by preference 0.5 to wt % and in particular 3 to 10 wt %, based in each case on the total weight of the automatic dishwashing agent.

Preferred copolymeric polysulfonates contain, besides sulfonic acid group-containing monomer(s), at least one monomer from the group of the unsaturated carboxylic acids.

Unsaturated carboxylic acids of the formula R¹(R²)C═C(R³)COOH are used with particular preference as (an) unsaturated carboxylic acid(s), in which formula R¹ to R³, mutually independently, denote —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues as defined above substituted with —NH₂, —OH, or —COOH, or denote —COOH or —COOR⁴ where R⁴ is a saturated or unsaturated, straight-chain or branched hydrocarbon residue having 1 to 12 carbon atoms.

Particularly preferred unsaturated carboxylic acids are acrylic acid, methacrylic acid, ethacrylic acid, [symbol] -chloroacrylic acid, [symbol] -cyanoacrylic acid, crotonic acid, [symbol] -phenylacrylic acid, maleic acid, maleic acid anhydride, fumaric acid, itaconic acid, citraconic acid, methylenemalonic acid, sorbic acid, cinnamic acid, or mixtures thereof. The unsaturated dicarboxylic acids are of course also usable.

In the context of the sulfonic acid group-containing monomers, those of the formula

R⁵(R⁶)C═C(R⁷)—X—SO₃H,

in which R⁵ to R⁷, mutually independently, denote —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues as defined above substituted with —NH₂, —OH, or —COOH, or denote —COOH or —COOR⁴, where R⁴ is a saturated or unsaturated, straight-chain or branched hydrocarbon residue having 1 to 12 carbon atoms, and X denotes an optionally present spacer group that is selected from —(CH₂)ₙ— where n=0 to 4, —COO—(CH₂)ₖ— where k=1 to 6, —C(O)—NH—C(CH₃)₂—, —C(O)—NH—C(CH₃)₂—CH₂—, and —C(O)—NH—CH(CH₂CH₃)—, are preferred.

Among these monomers, those of the formulas

H₂C═CH—X—SO₃H

H₂C═C(CH₃)—X—SO₃H

HO₃S—X—(R⁶)C═C(R⁷)—X—SO₃—H,

in which R⁶ and R⁷, mutually independently, are selected from —H, —CH₃, □CH₂CH₃, —CH₂CH₂CH₃, —CH(CH₃)₂, and X denotes an optionally present spacer group that is selected from —(CH₂)ₙ— where n=0 to 4, —COO(CH₂)ₖ— where k=1 to 6, —C(O)—NH—C(CH₃)₂—, —C(O)—NH—C(CH₃)₂—CH₂, and —C(O)—NH—CH(CH₂CH₃)—, are preferred.

Particularly preferred sulfonic acid group-containing monomers in this context are 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropylacrylate, 3-sulfopropylmethacrylate, sulfomethacrylamide, sulfomethylmethacrylamide, and mixtures of the aforesaid acids or of water-soluble salts thereof.

The sulfonic acid groups can be present in the polymers entirely or partly in neutralized form, i.e. the acid hydrogen atom of the sulfonic acid group can, in some or all sulfonic acid groups, be exchanged for metal ions, by preference alkali metal ions, and in particular for sodium ions. The use of partly or entirely neutralized sulfonic acid group-containing copolymers is preferred according to the present invention.

In a further preferred embodiment, the copolymers also encompass, besides carboxyl group-containing monomers and sulfonic acid group-containing monomers, at least one nonionic, by preference hydrophobic monomer. The use of these hydrophobically modified polymers has made it possible to improve, in particular, the rinsing performance of automatic dishwashing agents according to the present invention.

Automatic cleaning-agent preparations A that contain as an anionic copolymer a copolymer encompassing
i) carboxylic acid group-containing monomer(s),
ii) sulfonic acid group-containing monomer(s),
iii) nonionic monomer(s),
   are preferred according to the present invention.

The nonionic monomers used are by preference monomers of the general formula R(R²)C═C(R³)—X—R⁴, in which R¹ to R³, mutually independently, denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, preferably aromatic residue having 6 to 22 carbon atoms.

Particularly preferred nonionic monomers are butene, isobutene, pentene, 3-methylbutene, 2-methylbutene, cyclopentene, hexene, hexene-1,2-methlypentene-1,3-methlypentene-1, cyclohexene, methylcyclopentene, cycloheptene, methylcyclohexene, 2,4,4-trimethylpentene-1,2,4,4-trimethylpentene-2,2,3-dimethylhexene-1,2,4-dimethylhexene-1,2,5-dimethlyhexene-1,3,5-dimethylhexene-1,4,4-dimethylhexane-1, ethylcyclohexyne, 1-octene, [symbol] -olefins having 10 or more carbon atoms such as, for example, 1-decene, 1-dodecene, 1-hexadecene, 1-octadecene, and C22- [symbol] -olefin, 2-styrene, [symbol] -methylstyrene, 3-methylstyrene, 4-propylstryene, 4-cyclohexylstyrene, 4-dodecylstyrene, 2-ethyl-4-benzylstyrene, 1-vinylnaphthalene, 2-vinylnaphthalene, acrylic acid methyl ester, acrylic acid ethyl ester, acrylic acid propyl ester, acrylic acid butyl ester, acrylic acid pentyl ester, acrylic acid hexyl ester, methacrylic acid methyl ester, N-(methyl)acrylamide, acrylic acid 2-ethylhexyl ester, methacrylic acid 2-ethylhexyl ester, N-(2-ethylhexyl)acrylamide, acrylic acid octyl ester, methacrylic acid octyl ester, N-(octyl)acrylamide, acrylic acid lauryl ester, methacrylic acid lauryl ester, N-(lauryl)acrylamide, acrylic acid stearyl ester, methacrylic acid stearyl ester, N-(stearyl)acrylamide, acrylic acid behenyl ester, methacrylic acid behenyl ester, and N-(behenyl)acrylamide, or mixtures thereof.

The compositions of some preferred liquid cleaning-agent preparations according to the present invention may be gathered from the tables below. These cleaning-agent combinations are suitable in particular for use in a method according to the present invention.

| | | | |
|---|---|---|---|
| 1 | 2 | 3 | 4 |

Cleaning-agent preparation A: wt % based on
cleaning-agent preparation A

| | | | | |
|---|---|---|---|---|
| Builder | 15 to 60 | 20 to 50 | 20 to 50 | 20 to 50 |
| Water | yes | yes | yes | yes |
| Misc. | to 100 | to 100 | to 100 | to 100 |

Cleaning-agent preparation B: wt % based on
cleaning-agent preparation B

| | | | | |
|---|---|---|---|---|
| Enzyme | yes | yes | yes | yes |
| preparation | | | | |
| Water | yes | yes | 2 to 50 | 2 to 50 |
| Misc. | to 100 | to 100 | to 100 | to 100 |

Cleaning-agent preparation C: wt % based on
cleaning-agent preparation C

| | | | | |
|---|---|---|---|---|
| Nonionic | yes | yes | yes | yes |
| surfactant | | | | |
| and/or acid | | | | |
| Water | yes | yes | yes | yes |
| Misc. | to 100 | to 100 | to 100 | to 100 |

| | | | |
|---|---|---|---|
| 1 | 2 | 3 | 4 |

Cleaning-agent preparation A: wt % based on
cleaning-agent preparation A

| | | | | |
|---|---|---|---|---|
| EDDS | 2.0 to 20 | 2.0 to 20 | 2.0 to 10 | 2.0 to 8.0 |
| Phosphonate | 0.5 to 20 | 2.0 to 18 | 2.0 to 18 | 4.0 to 14 |
| (Hydrogen) | 0 to 20 | 1.0 to 40 | 2.0 to 30 | 4.0 to 15 |
| carbonate | | | | |
| Alkali hydroxide | 0 to 22 | 1.0 to 22 | 4.0 to 20 | 8.0 to 18 |
| Anionic polymer | 0 to 30 | 1.0 to 30 | 2.0 to 25 | 5.0 to 20 |
| Water | 30 to 80 | 35 to 75 | 35 to 75 | 40 to 70 |
| Misc. | to 100 | to 100 | to 100 | to 100 |

Cleaning-agent preparation B: wt % based on
cleaning-agent preparation B

| | | | | |
|---|---|---|---|---|
| Enzyme | yes | yes | yes | yes |
| preparation | | | | |
| Misc. | to 100 | to 100 | to 100 | to 100 |

Cleaning-agent preparation C: wt % based on
cleaning-agent preparation C

| | | | | |
|---|---|---|---|---|
| Nonionic | yes | yes | yes | yes |
| surfactant | | | | |
| and/or acid | | | | |
| Misc. | to 100 | to 100 | to 100 | to 100 |

The cleaning-agent preparation B contains as an essential constituent at least one enzyme preparation having cleaning activity. The weight proportion of the enzyme preparation(s) having cleaning activity in terms of the total weight of the cleaning-agent preparation B is equal to by preference 10 to 60 wt %, preferably 20 to 55 wt %, and in particular 30 to 55 wt %. Enzyme preparations having cleaning activity from the group of amylase, protease, and lipase preparations are used in particular as enzyme preparations having cleaning activity.

Included among the enzymes used with particular preference are, in particular, proteases, amylases, lipases, hemicellulases, cellulases, perhydrolases, or oxidoreductases, as well as, by preference, mixtures thereof. These enzymes are in principle of natural origin; proceeding from the natural molecules, improved variants are available for use in washing or cleaning agents and are used in correspondingly preferred fashion. Washing or cleaning agents contain enzymes by preference in total quantities from 1×10⁻⁶ to 5 wt %, based on active protein. The protein concentration can be determined with the aid of known methods, for example the BCA method or the biuret method.

Liquid cleaning-agent preparations B preferred according to the present invention contain, based on their total weight, 0.1 to 30 wt %, by preference 1.0 to 25 wt %, and in particular 2.0 to 20 wt % cellulase preparations.

Among the proteases, those of the subtilisin type are preferred. Examples thereof are the subtilisins BPN′ and Carlsberg and further developed forms thereof, protease PB92, subtilisins 147 and 309, the alkaline protease from Bacillus lentus, subtilisin DY, and the enzymes (to be classified, however, as subtilases and no longer as subtilisins in the strict sense) thermitase, proteinase K, and the proteases TW3 and TW7.

Liquid cleaning-agent preparations B preferred according to the present invention contain, based on their total weight, 5 to 50 wt %, by preference 7 to 40 wt %, and in particular 10 to 30 wt % protease preparations. Cleaning-agent preparations B that contain, based on their total weight, 15 to 25 wt % protease preparations are particularly preferred.

Examples of amylases usable according to the present invention are the [symbol] -amylases from Bacillus licheniformis, from B. anmyloliquefaciens, from B. stearothermophilus, from Aspergillus niger and A. oryzae, and the further developments of the aforementioned amylases improved for use in washing and cleaning agents. Additionally to be highlighted for this purpose are the [symbol] -amylase from Bacillus sp. A 7-7 (DSM 12368) and the cyclodextrin-glucanotransferase (CGTase) from B. agaradherens (DSM 9948).

Liquid cleaning-agent preparations B preferred according to the present invention contain, based on their weight, 0.1 to 30 wt %, by preference 1.0 to 25 wt %, and in particular 2.0 to 20 wt % amylase preparations. Cleaning-agent preparations B that contain, based on their total weight, 4.0 to 16 wt % amylase preparations are particularly preferred.

Proteases and amylases having cleaning activity are made available as a rule not in the form of the pure protein but instead in the form of stabilized, storable and transportable preparations. Included among these prepackaged preparations are, for example, the solid preparations obtained by granulation, extrusion, or lyophilization or, especially in the case of liquid or gelled agents, solutions of the enzymes, advantageously as concentrated as possible, low in water, and/or with stabilizers or further adjuvants added.

As is apparent from the statements above, the enzyme protein constitutes only a fraction of the total weight of usual enzyme preparations. Protease and amylase preparations used in preferred fashion according to the present invention contain between 0.1 and 40 wt %, preferably between 0.2 and 30 wt %, particularly preferably between 0.4 and 20 wt %, and in particular between 0.8 and 10 wt % of the enzyme protein.

Lipases or cutinases are also usable according to the present invention, in particular because of their triglyceride-cleaving activities but also in order to generate peracids in situ from suitable precursors. Included thereamong are, for example, the lipases obtainable originally from Humicola lanuginosa (Thermomyces lanuginosus) resp. further-developed lipases, in particular those having the D96L amino acid exchange. Also usable, for example, are the cutinases that were originally isolated from Fusarium solani pisi and Humicola insolens. Lipases resp. cutinases whose starting enzymes were originally isolated from Pseudomonas mendocina and Fusarium solanii are furthermore usable.

Enzymes that are grouped under the term “hemicellulases” can also be used. These include, for example, mannanases, xanthanlyases, pectinlyases (=pectinases), pectinesterases, pectatelyases, xyloglucanases (=xylanases), pullulanases, and β-glucanases.

Oxidoreductases, for example oxidases, oxygenases, catalases, peroxidases such as halo-, chloro-, bromo-, lignin, glucose, or manganese peroxidases, dioxygenases, or laccases (phenoloxidases, polyphenoloxidases) can be used according to the present invention to enhance the bleaching effect. Advantageously, preferably organic, particularly preferably aromatic compounds that interact with the enzymes are additionally added in order to enhance the activity of the relevant oxidoreductases (enhancers) or, if there is a large difference in redox potentials between the oxidizing enzymes and the stains, to ensure electron flow (mediators).

It is preferred to use multiple enzymes and/or enzyme preparations, by preference liquid protease preparations and/or amylase preparations and/or lipase preparations.

A second preferred constituent of the cleaning-agent preparations B used according to the present invention is cumolsulfonate. In the context of the cumolsulfonates, para-isopropylbenzenesulfonate represents the preferred compound.

Surprisingly, cumolsulfonate has emerged as being superior, in terms of its stabilizing properties, not only to solvents such as glycerol, triacetin, or diethylene glycol, but also to hydrotropes such as xylenesulfonate.

Preferred cleaning-agent preparations B according to the present invention are characterized in that said cleaning-agent preparations contain cumolsulfonate in quantities from 0.5 to 60 wt %, by preference in quantities between 1.0 and 50 wt %, preferably in quantities between 2.0 and 40 wt %, and in particular in quantities between 5.0 and 30 wt %, based in each case on the total weight of the cleaning-agent preparations. Weight proportions of cumolsulfonate in terms of the total weight of the cleaning-agent preparation B between 2.0 and 20 wt %, by preference between 3.0 and 18 wt %, and in particular between 4.0 and 15 wt % are particularly preferred.

The addition of solubilizers such as alkylbenzenesulfonates, in particular cumolsulfonate, has also proven advantageous for the stability of the further cleaning-agent preparations A and C. Automatic dishwashing methods according to the present invention, wherein at least one of the cleaning-agent preparations A, B, or C encompasses a solubilizer, by preference an alkylbenzenesulfonate, in particular cumolsulfonate, the weight proportion of the solubilizer in terms of the total weight of the cleaning-agent preparation C being equal to by preference 1.0 to 18 wt %, preferably 2.0 to 15 wt %, and in particular 4.0 to 12 wt %.

A further preferred constituent of the cleaning-agent preparations B used according to the present invention is an organic solvent. Preferred organic solvents derive from the group of the monovalent or polyvalent alcohols, alkanolamines, or glycol ethers. The solvents are by preference selected from ethanol, n-propanol or isopropanol, butanol, glycol, propanediol or butanediol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, or propylene glycol propyl ether, dipropylene glycol methyl ether or dipropylene glycol ethyl ether, methoxy-, ethoxy-, or butoxytriglycol, 1-butoxyethoxy-2-propanol, 3-methyl-3-methoxybutanol, propylene glycol t-butyl ether, and mixtures of these solvents. The weight proportion of these organic solvents in terms of the total weight of cleaning-agent preparations B according to the present invention is equal to by preference 5 to 80 wt %, preferably 8 to 60 wt %, and in particular 10 to 50 wt %.

An organic solvent that is particularly preferred and is particularly effective with respect to stabilization of the cleaning-agent preparation is 1,2-propylene glycol. The weight proportion of 1,2-propylene glycol in terms of the total weight of the cleaning-agent preparations B according to the present invention can vary within wide limits, but those preparations that contain an organic solvent, by preference 1,2-propylene glycol, such that the weight proportion of 1,2-propylene glycol, based in each case on the total weight of the cleaning-agent preparations, is equal to by preference 5 to 80 wt %, preferably 8 to 60 wt %, and in particular 10 to 50 wt %, have proven particularly stable.

A second preferred constituent of the cleaning-agent preparations B according to the present invention is boric acid resp. a boric acid derivative. Used for this by preference, besides boric acid, are in particular boronic acids or salts or esters thereof, among them principally derivatives having aromatic groups, e.g. ortho-, meta-, or para-substituted phenylboronic acids, in particular 4-formylphenylboronic acid (4-FPBA), resp. the salts or esters of the aforesaid compounds. The weight proportion of boric acid resp. the boric acid derivative in terms of the total weight of cleaning-agent preparations B according to the present invention is equal to by preference between 0.001 and 10 wt %, preferably 0.002 to 6 wt %, and in particular 0.05 to 3 wt %.

A particularly preferred boric acid derivative that is particularly effective with respect to stabilization of the cleaning-agent preparation B is 4-formylphenylboronic acid. The weight proportion of 4-formylphenylboronic acid in terms of the total weight of the cleaning-agent preparations B according to the present invention can vary within wide limits, but those preparations that contain, based on the total weight of the cleaning-agent preparation B, 0.001 to 10 wt %, preferably 0.002 to 6 wt %, and in particular 0.05 to 3 wt % have proven particularly stable. Corresponding preparations are therefore preferred according to the present invention.

A third preferred constituent of the cleaning-agent preparations B according to the present invention is a Ca-ion or Mg-ion source. The weight proportion of the Ca- or Mg-ion source in terms of the total weight of cleaning-agent preparations B according to the present invention is equal to by preference between 0.01 and 10 wt %, preferably 0.2 to 8 wt %, and in particular 0.5 to 5 wt %.

The organic calcium salts have proven to be particularly preferred Ca-ion sources that are particularly effective with respect to stabilization of the cleaning-agent preparation B. The weight proportion of the organic calcium salts in terms of the total weight of the cleaning-agent preparations B according to the present invention can vary within wide limits, but those preparations that contain, based on the total weight of the cleaning-agent preparation, 0.01 to 10 wt %, preferably 0.2 to 8 wt %, and in particular 0.5 to 5 wt % have proven to be particularly stable. Corresponding preparations are therefore preferred according to the present invention. With particular preference, the cleaning-agent preparations B contain calcium lactate.

A further preferred constituent of the cleaning-agent preparations B according to the present invention is lastly the nonionic surfactants, nonionic surfactants of the general formula R¹—CH(OH)CH₂O-(AO)_{w}-(A′O)ₓ-(A″O)_{y}-(A′″O)_{z}—R², in which
R¹ denotes a straight-chain or branched, saturated or mono- or polyunsaturated C₆₋₂₄ alkyl or alkenyl residue;
R² denotes a linear or branched hydrocarbon residue having 2 to 26 carbon atoms;
A, A′, A″, and A′″, mutually independently, denote a residue from the group —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃),
w, x, y, and z denote values between 0.5 and 120, such that x, y, and/or z can also be 0
   being preferred.

The weight proportion of these nonionic surfactants in preferred liquid cleaning-agent preparations B, based on the total weight of the cleaning-agent preparation B, is equal to 0.5 to 30 wt %, by preference 2.0 to 25 wt %, and in particular 5.0 to 20 wt %.

As a result of the addition of the aforesaid nonionic surfactants of the general formula R¹—CH(OH)CH₂O-(AO)_{w}-(A′O)ₓ-(A″O)_{y}-(A′″O)_{z}—R², hereinafter also referred to as “hydroxy mixed ethers,” it is possible, surprisingly, to considerably improve the cleaning performance of enzyme-containing preparations according to the present invention, both in comparison with a surfactant-free system and in comparison with systems that contain alternative nonionic surfactants, for example from the group of the polyalkoxylated fatty alcohols.

The stability of the enzymes contained in the washing- or cleaning-agent preparations according to the present invention can be considerably improved by the use of these nonionic surfactants having one or more free hydroxyl groups on one or both terminal alkyl residues.

Those end-capped poly(oxyalkylated) nonionic surfactants that, in accordance with the formula R¹O[CH₂CH₂O]ₓCH₂CH(OH)R², besides a residue R¹ that denotes linear or branched, saturated or unsaturated, aliphatic or aromatic hydrocarbon residues having 2 to 30 carbon atoms, by preference having 4 to 22 carbon atoms, additionally contain a linear or branched, saturated or unsaturated, aliphatic or aromatic hydrocarbon residue R² having 1 to 30 carbon atoms, where x denotes values between 1 and 90, by preference values between 30 and 80, and in particular values between 30 and 60, are particularly preferred.

Surfactants of the formula R¹O[CH₂CH(CH₃)O]ₓ[CH₂CH₂O]_{y}CH₂CH(OH)R², in which R¹ denotes a linear or branched aliphatic hydrocarbon residue having 4 to 18 carbon atoms or mixtures thereof, R² denotes a linear or branched hydrocarbon residue having 2 to 26 carbon atoms or mixtures thereof, and x denotes values between 0.5 and 1.5 and y denotes a value of at least 15, are particularly preferred.

The group of these nonionic surfactants includes, for example, the C₂₋₂₆ fatty alcohol-(PO)₁-(EO)₁₅₋₄₀-2-hydroxyalkyl ethers, in particular also the C₂₋₁₀ fatty alcohol-(PO)₁-(EO)₂₂-2-hydroxydecyl ethers.

Also particularly preferred are those end-capped poly(oxyalkylated) nonionic surfactants of the formula R¹O[CH₂CH₂O][CH₂CH(R³)O]_{y}CH₂CH(OH)R², in which R¹ and R², mutually independently, denote a linear or branched, saturated or mono- resp. polyunsaturated hydrocarbon residue having 2 to 26 carbon atoms, R³ is selected, mutually independently, from —CH₃, —CH₂CH₃, —CH₃CH₂—CH₃, —CH(CH₃)₂, but by preference denotes —CH₃, and x and y, mutually independently, denote values between 1 and 32, nonionic surfactants where R³=-CH₃ and having values for x from 15 to 32, and for y from 0.5 to 1.5, being very particularly preferred.

Further nonionic surfactants usable in preferred fashion are the end-capped poly(oxyalkylated) nonionic surfactants of the formula R¹O[CH₂CH(R³)O]ₓ[CH₂]ₖCH(OH)[CH₂]ⱼOR², in which R¹ and R² denote linear or branched, saturated or unsaturated, aliphatic or aromatic hydrocarbon residues having 1 to 30 carbon atoms; R³ denotes H or a methyl, ethyl, n-propyl, isopropyl, n-butyl, 2-butyl, or 2-methyl-2-butyl residue; x denotes values between 1 and 30; and k and j denote values between 1 and 12, by preference between 1 and 5. If the value of x is greater than or equal to 2, each R³ in the above formula R¹O[CH₂CH(R³)O]ₓ[CH₂]ₖCH(OH)[CH₂]ⱼOR² can be different. R¹ and R² are by preference linear or branched, saturated or unsaturated, aliphatic or aromatic hydrocarbon residues having 6 to 22 carbon atoms, residues having 8 to 18 carbon atoms being particularly preferred. For the R³ residue, H, —CH₃, or —CH₂CH₃ are particularly preferred. Particularly preferred values for x are in the range from 1 to 20, in particular from 6 to 15.

As described above, each R³ in the formula above can be different if x≧2. The alkylene oxide unit within square brackets can thereby be varied. If, for example, x denotes 3, the R³ residue can be selected so as to form ethylene oxide units (R³═H) or propylene oxide units (R³═CH₃), which can be joined to one another in any sequence, for example (EO)(PO)(EO), (EO)(EO)(PO), (EO)(EO)(EO), (PO)(EO)(PO), (PO)(PO)(EO), and (PO)(PO)(PO). The value of 3 for x was selected here as an example, and can certainly be larger; the range of variation increases with rising values of x and includes, for example, a large number of (EO) groups combined with a small number of (PO) groups, or vice versa.

Particularly preferred end-capped poly(oxyalkylated) alcohols of the above formula have values of k=1 and j=1, so that the formula above is simplified to R¹O[CH₂CH(R³)O]ₓCH₂CH(OH)CH₂OR². In the latter formula, R¹, R², and R³ are as defined above, and x denotes numbers from 1 to 30, by preference from 1 to 20, and in particular from 6 to 18. Surfactants in which the R¹ and R² residues have 9 to 14 carbon atoms, R³ denotes H, and x assumes values from 6 to 15, are particularly preferred.

Lastly, the nonionic surfactants of the general formula R¹—CH(OH)CH₂O-(AO)_{w}—R² in which
R¹ denotes a straight-chain or branched, saturated or mono- resp. polyunsaturated C₆₋₂₄ alkyl or alkenyl residue;
R² denotes a linear or branched hydrocarbon residue having 2 to 26 carbon atoms;
A denotes a residue from the group CH₂CH₂, CH₂CH₂CH₂, —CH₂—CH(CH₃); and
w denotes values between 1 and 120, by preference 10 to 80, in particular 20 to 40 have proven particularly effective.

The group of these nonionic surfactants includes, for example, the C₄₋₂₂ fatty alcohol-(EO)₁₀₋₈₀ so-2-hydroxyalkyl ethers, in particular also the C₈₋₁₂ fatty alcohol-(EO)₂₂-2-hydroxydecyl ethers and the C₄₋₂₂ fatty alcohol-(EO)₄₀₋₈₀-2-hydroxyalkyl ethers.

In addition to the ingredients described earlier on, such as enzymes, solvents, and nonionic surfactants from the group of the hydroxy mixed ethers, the cleaning-agent preparations B according to the present invention can contain further ingredients, for example active substances from the group of the builders, bleaching agents, polymers having washing and cleaning activity, corrosion inhibitors, scents, or dyes. In contrast to usual washing or cleaning agents, however, preferred cleaning-agent preparations B according to the present invention contain these further ingredients only to a subordinate extent.

Those cleaning-agent preparations B that contain less than 20 wt %, by preference less than 10 wt %, and in particular less than 5 wt % builders are particularly preferred according to the present invention. In particular, those cleaning-agent preparations B that are free of builders are particularly preferred.

Those cleaning-agent preparations B that contain less than 10 wt %, by preference less than 5 wt %, and in particular less than 2 wt % bleaching agent are furthermore particularly preferred. In particular, those cleaning-agent preparations B that are free of bleaching agents are particularly preferred.

The automatic dishwashing preparations B used in the methods according to the present invention are by preference low-alkalinity; their pH (20° C.) is equal to preferably between 6.5 and 8.5, and in particular between 7 and 8. The pH (20° C.) of the automatic cleaning agent D is equal to by preference between 4.0 and 7.0, preferably between 5.0 and 6.0. The pH values (20° C.) of the dishwashing preparations B and D differ by preference by no more than 3.0 units, by preference by no more than 2.0 units.

Despite the low alkalinity of the cleaning-agent preparations used, the agents according to the present invention are notable for very good cleaning performance. This is all the more surprising given that an alkaline cleaning bath is regarded as an essential basis for the cleaning result of automatic dishwashing methods.

The compositions of some preferred liquid cleaning-agent preparations according to the present invention may be gathered from the tables below. These cleaning-agent combinations are suitable in particular for use in a method according to the present invention.

| | | | |
|---|---|---|---|
| 1 | 2 | 3 | 4 |

Cleaning-agent preparation A: wt % based on
cleaning-agent preparation A

| | | | | |
|---|---|---|---|---|
| Builder | 15 to 60 | 20 to 50 | 20 to 50 | 20 to 50 |
| Water | yes | yes | yes | yes |
| Misc. | to 100 | to 100 | to 100 | to 100 |

Cleaning-agent preparation B: wt % based on
cleaning-agent preparation B

| | | | | |
|---|---|---|---|---|
| Enzyme | 10 to 60 | 10 to 60 | 30 to 55 | 30 to 55 |
| preparation | | | | |
| Nonionic | 0 to 30 | 0.5 to 30 | 2.0 to 25 | 5.0 to 20 |
| surfactant | | | | |
| Organic solvent | 0 to 80 | 5.0 to 80 | 8.0 to 60 | 10 to 50 * |
| Cumolsulfonate | 0 to 20 | 2.0 to 20 | 3.0 to 18 | 4.0 to 15 |
| Misc. | to 100 | to 100 | to 100 | to 100 |

Cleaning-agent preparation C: wt % based on
cleaning-agent preparation C

| | | | | |
|---|---|---|---|---|
| Nonionic | yes | yes | yes | yes |
| surfactant | | | | |
| and/or acid | | | | |
| Misc. | to 100 | to 100 | to 100 | to 100 |

* 1,2-propylene glycol

| | | | |
|---|---|---|---|
| 1 | 2 | 3 | 4 |

Cleaning-agent preparation A: wt % based on
cleaning-agent preparation A

| | | | | |
|---|---|---|---|---|
| EDDS | 2.0 to 20 | 2.0 to 20 | 2.0 to 10 | 2.0 to 8.0 |
| Phosphonate | 0.5 to 20 | 2.0 to 18 | 2.0 to 18 | 4.0 to 14 |
| (Hydrogen) | 0 to 20 | 1.0 to 40 | 2.0 to 30 | 4.0 to 15 |
| carbonate | | | | |
| Alkali hydroxide | 0 to 22 | 1.0 to 22 | 4.0 to 20 | 8.0 to 18 |
| Anionic polymer | 0 to 30 | 1.0 to 30 | 2.0 to 25 | 5.0 to 20 |
| Water | 30 to 80 | 35 to 75 | 35 to 75 | 40 to 70 |
| Misc. | to 100 | to 100 | to 100 | to 100 |

Cleaning-agent preparation B: wt % based on
cleaning-agent preparation B

| | | | | |
|---|---|---|---|---|
| Enzyme | 10 to 60 | 10 to 60 | 30 to 55 | 30 to 55 |
| preparation | | | | |
| Organic solvent | 0 to 80 | 5.0 to 80 | 8.0 to 60 | 10 to 50 * |
| Misc. | to 100 | to 100 | to 100 | to 100 |

Cleaning-agent preparation C: wt % based on
cleaning-agent preparation C

| | | | | |
|---|---|---|---|---|
| Nonionic | yes | yes | yes | yes |
| surfactant | | | | |
| and/or acid | | | | |
| Misc. | to 100 | to 100 | to 100 | to 100 |

* 1,2-propylene glycol

| | | | |
|---|---|---|---|
| 1 | 2 | 3 | 4 |

Cleaning-agent preparation A: wt % based on
cleaning-agent preparation A

| | | | | |
|---|---|---|---|---|
| EDDS | 2.0 to 20 | 2.0 to 20 | 2.0 to 10 | 2.0 to 8.0 |
| Phosphonate | 0.5 to 20 | 2.0 to 18 | 2.0 to 18 | 4.0 to 14 |
| (Hydrogen) | 0 to 20 | 1.0 to 40 | 2.0 to 30 | 4.0 to 15 |
| carbonate | | | | |
| Alkali hydroxide | 0 to 22 | 1.0 to 22 | 4.0 to 20 | 8.0 to 18 |
| Anionic polymer | 0 to 30 | 1.0 to 30 | 2.0 to 25 | 5.0 to 20 |
| Water | 30 to 80 | 35 to 75 | 35 to 75 | 40 to 70 |
| Misc. | to 100 | to 100 | to 100 | to 100 |

Cleaning-agent preparation B: wt % based on
cleaning-agent preparation B

| | | | | |
|---|---|---|---|---|
| Enzyme | 10 to 60 | 10 to 60 | 30 to 55 | 30 to 55 |
| preparation | | | | |
| Nonionic | 0 to 30 | 0.5 to 30 | 2.0 to 25 | 5.0 to 20 |
| surfactant | | | | |
| Organic solvent | 0 to 80 | 5.0 to 80 | 8.0 to 60 | 10 to 50 * |
| Cumolsulfonate | 0 to 20 | 2.0 to 20 | 3.0 to 18 | 4.0 to 15 |
| Misc. | to 100 | to 100 | to 100 | to 100 |

Cleaning-agent preparation C: wt % based on
cleaning-agent preparation C

| | | | | |
|---|---|---|---|---|
| Nonionic | yes | yes | yes | yes |
| surfactant | | | | |
| and/or acid | | | | |
| Misc. | to 100 | to 100 | to 100 | to 100 |

* 1,2-propylene glycol

In the automatic dishwashing method according to the present invention, the cleaning-agent preparations A and B are used in combination with at least one further cleaning-agent preparation C. This cleaning-agent preparation C is surfactant- and/or acid-containing for use in a dishwashing method, and for use in a textile washing method contains at least one compound selected from textile conditioning agents, defoamers, complexing agents, and perfume substances.

The rinsing performance achieved in the methods according to the present invention can be improved by the use of a surfactant- and/or acid-containing cleaning-agent preparation C. This applies in particular to those preferred method variants in which the dispensing of the cleaning-agent preparations A, B, and C occurs, as described earlier, in time-offset fashion. The nonionic surfactants already described earlier on are particularly suitable as surface-active additives for the cleaning-agent preparation C. The weight proportion of the nonionic surfactant in terms of the total weight of the cleaning-agent preparation C is equal to by preference between from 1.0 to 18 wt %, preferably from 2.0 to 15, particularly preferably from 4.0 to 12 wt %, and in particular from 6.0 to wt %

As a supplement or alternatively to the nonionic surfactants, the cleaning-agent preparations C according to the present invention contain by preference at least one acidifying agent. Acidifying agents can be added to the cleaning-agent preparations C according to the present invention in order to lower the pH of the bath in the rinsing step. Both inorganic acids and organic acids are appropriate here, provided they are compatible with the other ingredients. For reasons of consumer protection and handling safety, the solid mono-, oligo-, and polycarboxylic acids are usable in particular. Of this group, citric acid, tartaric acid, succinic acid, malonic acid, adipic acid, maleic acid, fumaric acid, oxalic acid, and polyacrylic acid are in turn preferred. Organic sulfonic acids such as amidosulfonic acid are likewise usable. Sokalan® DCS (trademark of BASF), a mixture of succinic acid (max. 31 wt %), glutaric acid (max. 50 wt %) and adipic acid (max. 33 wt %), is commercially obtainable and likewise preferred for use as an acidifying agent in the context of the present invention. Cleaning-agent preparations C that, based on the total weight of the cleaning-agent preparation C, one or more acidifying agents, by preference mono-, oligo-, and polycarboxylic acids, particularly preferably tartaric acid, succinic acid, malonic acid, adipic acid, maleic acid, fumaric acid, oxalic acid, and polyacrylic acid, and in particular acetic acid and/or citric acid, in quantities from 0.1 to 12 wt %, preferably 0.2 to 10 wt %, and in particular 0.4 to 8.0 wt %, are preferred embodiments of the present invention.

For use in a textile washing method, cleaning preparations C according to the present invention contain by preference at least one compound selected from textile conditioning agents, defoamers, in particular polydimethylsiloxanes, complexing agents, and perfume substances. The textile conditioning agent is selected in this context by preference from textile softeners, in particular esterquats and quaternary silicone compounds, optical brighteners, and soil release active substances. Textile softeners are used particularly preferably in the cleaning preparation C. The textile softener is contained in cleaning preparations C according to the present invention by preference in a quantity from 2 to 30 wt %, in particular 4 to 20 wt %.

Reference is made to the published application WO 2007/087953 with regard to textile softeners usable by preference according to the present invention. The complexing agents used are by preference the compounds already recited previously. Reference is made to the published application WO 2008/101810 with regard to the perfume substances, optical brighteners, and soil release active substances that are usable, and the preferred utilization quantities thereof.

The above-described cleaning-agent preparations A, B, and C differ with regard to their compositions, i.e. are not identical.

The compositions of some preferred liquid cleaning-agent preparations according to the present invention may be gathered from the tables below. These cleaning-agent combinations are suitable in particular for use in a method according to the present invention.

| | | | |
|---|---|---|---|
| 1 | 2 | 3 | 4 |

Cleaning-agent preparation A: wt % based on
cleaning-agent preparation A

| | | | | |
|---|---|---|---|---|
| Builder | 15 to 60 | 20 to 50 | 20 to 50 | 20 to 50 |
| Water | yes | yes | yes | yes |
| Misc. | to 100 | to 100 | to 100 | to 100 |

Cleaning-agent preparation B: wt % based on
cleaning-agent preparation B

| | | | | |
|---|---|---|---|---|
| Enzyme | yes | yes | yes | yes |
| preparation | | | | |
| Misc. | to 100 | to 100 | to 100 | to 100 |

Cleaning-agent preparation C: wt % based on
cleaning-agent preparation C

| | | | | |
|---|---|---|---|---|
| Nonionic | 0.5 to 30 | 0.5 to 30 | 2.0 to 25 | 5.0 to 20 |
| surfactant | | | | |
| Organic acid | 0 to 8.0 | 0.1 to 8.0 | 0.2 to 6.0 | 0.4 to 5.0 |
| Water | 0 to 99 | 40 to 99 | 40 to 97 | 40 to 94 |
| Misc. | to 100 | to 100 | to 100 | to 100 |

* 1,2-propylene glycol

| | | | |
|---|---|---|---|
| 1 | 2 | 3 | 4 |

Cleaning-agent preparation A: wt % based on
cleaning-agent preparation A

| | | | | |
|---|---|---|---|---|
| EDDS | 2.0 to 20 | 2.0 to 20 | 2.0 to 10 | 2.0 to 8.0 |
| Phosphonate | 0.5 to 20 | 2.0 to 18 | 2.0 to 18 | 4.0 to 14 |
| (Hydrogen) | 0 to 20 | 1.0 to 40 | 2.0 to 30 | 4.0 to 15 |
| carbonate | | | | |
| Alkali hydroxide | 0 to 22 | 1.0 to 22 | 4.0 to 20 | 8.0 to 18 |
| Anionic polymer | 0 to 30 | 1.0 to 30 | 2.0 to 25 | 5.0 to 20 |
| Water | 30 to 80 | 35 to 75 | 35 to 75 | 40 to 70 |
| Misc. | to 100 | to 100 | to 100 | to 100 |

Cleaning-agent preparation B: wt % based on
cleaning-agent preparation B

| | | | | |
|---|---|---|---|---|
| Enzyme | yes | yes | yes | yes |
| preparation | | | | |
| Misc. | to 100 | to 100 | to 100 | to 100 |

Cleaning-agent preparation C: wt % based on
cleaning-agent preparation C

| | | | | |
|---|---|---|---|---|
| Nonionic | 0.5 to 30 | 0.5 to 30 | 2.0 to 25 | 5.0 to 20 |
| surfactant | | | | |
| Organic acid | 0 to 8.0 | 0.1 to 8.0 | 0.2 to 6.0 | 0.4 to 5.0 |
| Water | 0 to 99 | 40 to 99 | 40 to 97 | 40 to 94 |
| Misc. | to 100 | to 100 | to 100 | to 100 |

* 1,2-propylene glycol

| | | | |
|---|---|---|---|
| 1 | 2 | 3 | 4 |

Cleaning-agent preparation A: wt % based on
cleaning-agent preparation A

| | | | | |
|---|---|---|---|---|
| Builder | 15 to 60 | 20 to 50 | 20 to 50 | 20 to 50 |
| Water | yes | yes | yes | yes |
| Misc. | to 100 | to 100 | to 100 | to 100 |

Cleaning-agent preparation B: wt % based on
cleaning-agent preparation B

| | | | | |
|---|---|---|---|---|
| Enzyme | 10 to 60 | 10 to 60 | 30 to 55 | 30 to 55 |
| preparation | | | | |
| Nonionic | 0 to 30 | 0.5 to 30 | 2.0 to 25 | 5.0 to 20 |
| surfactant | | | | |
| Organic solvent | 0 to 80 | 5.0 to 80 | 8.0 to 60 | 10 to 50 * |
| Cumolsulfonate | 0 to 20 | 2.0 to 20 | 3.0 to 18 | 4.0 to 15 |
| Misc. | to 100 | to 100 | to 100 | to 100 |

Cleaning-agent preparation C: wt % based on
cleaning-agent preparation C

| | | | | |
|---|---|---|---|---|
| Nonionic | 0.5 to 30 | 0.5 to 30 | 2.0 to 25 | 5.0 to 20 |
| surfactant | | | | |
| Organic acid | 0 to 8.0 | 0.1 to 8.0 | 0.2 to 6.0 | 0.4 to 5.0 |
| Water | 0 to 99 | 40 to 99 | 40 to 97 | 40 to 94 |
| Misc. | to 100 | to 100 | to 100 | to 100 |

* 1,2-propylene glycol

| | | | |
|---|---|---|---|
| 1 | 2 | 3 | 4 |

Cleaning-agent preparation A: wt % based on
cleaning-agent preparation A

| | | | | |
|---|---|---|---|---|
| EDDS | 2.0 to 20 | 2.0 to 20 | 2.0 to 10 | 2.0 to 8.0 |
| Phosphonate | 0.5 to 20 | 2.0 to 18 | 2.0 to 18 | 4.0 to 14 |
| (Hydrogen) | 0 to 20 | 1.0 to 40 | 2.0 to 30 | 4.0 to 15 |
| carbonate | | | | |
| Alkali hydroxide | 0 to 22 | 1.0 to 22 | 4.0 to 20 | 8.0 to 18 |
| Anionic polymer | 0 to 30 | 1.0 to 30 | 2.0 to 25 | 5.0 to 20 |
| Water | 30 to 80 | 35 to 75 | 35 to 75 | 40 to 70 |
| Misc. | to 100 | to 100 | to 100 | to 100 |

Cleaning-agent preparation B: wt % based on
cleaning-agent preparation B

| | | | | |
|---|---|---|---|---|
| Enzyme | 10 to 60 | 10 to 60 | 30 to 55 | 30 to 55 |
| preparation | | | | |
| Nonionic | 0 to 30 | 0.5 to 30 | 2.0 to 25 | 5.0 to 20 |
| surfactant | | | | |
| Organic solvent | 0 to 80 | 5.0 to 80 | 8.0 to 60 | 10 to 50 * |
| Cumolsulfonate | 0 to 20 | 2.0 to 20 | 3.0 to 18 | 4.0 to 15 |
| Misc. | to 100 | to 100 | to 100 | to 100 |

Cleaning-agent preparation C: wt % based on
cleaning-agent preparation C

| | | | | |
|---|---|---|---|---|
| Nonionic | 0.5 to 30 | 0.5 to 30 | 2.0 to 25 | 5.0 to 20 |
| surfactant | | | | |
| Organic acid | 0 to 8.0 | 0.1 to 8.0 | 0.2 to 6.0 | 0.4 to 5.0 |
| Water | 0 to 99 | 40 to 99 | 40 to 97 | 40 to 94 |
| Misc. | to 100 | to 100 | to 100 | to 100 |

* 1,2-propylene glycol

Packaging of the above-described combination of cleaning agents occurs in the form of receiving chambers separated from one another, each of said receiving chambers containing one of the cleaning agents combined with one another. Examples of such packaging forms are cartridges having two, three, four, or more receiving chambers separated from one another, for example two-, three-, four-, or multi-chamber bottles. As a result of the separation of the cleaning agents having different compositions, undesired reactions due to chemical incompatibility can be ruled out.

Dispensing of the cleaning-agent preparations according to the present invention occurs by preference by means of a special dispensing system. In a preferred embodiment, the above-described cartridges of the cleaning-agent presentation forms are equipped with a dispenser detachable from the cartridge. A dispenser of this kind can be connected to the cartridge, for example, by means of an adhesive, latching, snap-on, or plug-in connection. Filling of the cartridge is simplified, for example, by the separation of the cartridge and dispenser. Alternatively, the detachable connection of the cartridge and dispenser enables replacement of the cartridges on the dispenser. Such replacement can be indicated, for example, upon a change in the cleaning program or after complete emptying of the cartridge.

A further subject of the present Application is a cleaning-agent dispensing system encompassing
a1) a preferably liquid cleaning-agent preparation A having a pH (10% solution in H₂O; 20° C.) above 8.0, containing at least one builder, in a quantity sufficient for carrying out an automatic dishwashing method at least twice, by preference at least four times, and in particular at least eight times;
a2) a preferably liquid cleaning-agent preparation B containing at least one enzyme preparation, in a quantity sufficient for carrying out an automatic dishwashing method at least twice, by preference at least four times, and in particular at least eight times;
a3) optionally, a preferably liquid cleaning-agent preparation C containing at least one nonionic surfactant and/or one acid, in a quantity sufficient for carrying out an automatic dishwashing method at least twice, by preference at least four times, and in particular at least eight times;
b) a cartridge for the cleaning-agent preparations, in which the cleaning-agent preparations are present in receiving chambers separated from one another;
c) a dispenser connected or connectable to the cartridge.

A further subject of the present Application is a cleaning-agent dispensing system encompassing
a1) a preferably liquid cleaning-agent preparation A having a pH (10% solution in H₂O; 20° C.) above 8.0, containing at least one builder, in a quantity sufficient for carrying out an automatic textile washing method at least twice, by preference at least four times, and in particular at least eight times;
a2) a preferably liquid cleaning-agent preparation B containing at least one enzyme preparation, in a quantity sufficient for carrying out an automatic textile washing method at least twice, by preference at least four times, and in particular at least eight times;
a3) optionally, a preferably liquid cleaning-agent preparation C containing at least one nonionic surfactant and/or one acid, in a quantity sufficient for carrying out an automatic textile washing method at least twice, by preference at least four times, and in particular at least eight times;
b) a cartridge for the cleaning-agent preparations, in which the cleaning-agent preparations are present in receiving chambers separated from one another;
c) a dispenser connected or connectable to the cartridge.

The cartridge and the dispenser are by preference connected detachably to one another, but can also be connected nondetachably to one another.

In a preferred embodiment, the aforesaid cleaning-agent dispensing systems encompassing cleaning-agent preparations according to the present invention, a cartridge, and a dispenser connected detachably or nondetachably to the cartridge are present in a common enclosing package, the filled cartridge and the dispenser being, particularly preferably, contained separately from one another in the enclosing package. The enclosing package serves for storage, transport, and presentation of the cleaning-agent presentation form according to the present invention and protects it from soiling, impact, and shock. For the purpose of product presentation especially, the enclosing package should be embodied to be transparent at least in part.

Alternatively or as a supplement to an enclosing package, the possibility of course exists of marketing the cleaning-agent presentation forms according to the present invention in conjunction with an automatic dishwasher resp. textile washing machine. Such a combination is advantageous in particular in those cases in which the execution sequence of the automatic dishwashing method resp. textile washing method (e.g. duration, temperature profile, water delivery) and the cleaning-agent formulation resp. the control electronics of the dispenser are coordinated with one another.

The dispensing system according to the present invention is made up of the basic modules of a cleaning-agent presentation form according to the present invention and a dispenser couplable to the cartridge, which dispenser is in turn constituted from further assemblies such as, for example, a component carrier, actuator, closure element, sensor, energy source, and/or control unit.

It is preferred that the dispensing system according to the present invention be movable. “Movable” for purposes of this Application means that the dispensing system is not connected nondetachably to a water-conveying apparatus such as, for example, an automatic dishwasher, washing machine, laundry dryer, or the like, but instead can, for example, be removed from an automatic dishwasher or positioned in an automatic dishwasher by the user, i.e. can be handled independently.

According to an alternative embodiment of the invention, it is also conceivable for the dispenser to be connected to a water-conveying apparatus such as, for example, an automatic dishwasher, washing machine, laundry dryer, or the like in a manner not detachable by the user, and for only the cartridge to be movable.

### Cartridge

For purposes of the present Application, a “cartridge” is understood as a packaging means that is suitable for encasing or holding together flowable or scatterable preparations, and is couplable to a dispenser for delivery of the preparation.

In particular, a cartridge can also encompass multiple chambers that are fillable with compositions differing from one another. It is also conceivable for a plurality of containers to be arranged into one cartridge unit.

In a further embodiment of the invention, the cartridge is embodied in one piece. As a result, the cartridges can be embodied economically in one manufacturing step, in particular using suitable blow molding methods. The chambers of a cartridge can in this context be separated from one another by, for example, webs or material bridges.

The cartridge can also be formed from multiple pieces, using components manufactured by injection molding and then joined together.

It is furthermore conceivable for the cartridge to be shaped in multi-piece fashion such that at least one chamber, preferably all the chambers, are individually removable from or insertable into the dispenser. This makes it possible, if a preparation from one chamber is consumed at a different rate, to replace an already empty chamber while the others, which may still be filled with preparation, remain in the dispenser. Targeted and demand-compatible refilling of the individual chambers resp. their preparations can thereby be achieved.

The chambers of a cartridge can be fastened to one another using suitable connection methods, thereby forming a container unit. The chambers can be fastened detachably or nondetachably to one another by a suitable positive, frictionally engaged, or integral connection. In particular, fastening can be effected by one or more of the connection types from the group of the snap-in connections, hook-and-loop connections, press connections, melt connections, adhesive connections, welded connections, soldered connections, screw connections, keyed connections, clamped connections or flip-closure connections. In particular, fastening can also be embodied by a heat-shrink sleeve, which in a heated state is pulled over all or portions of the cartridge, and in the cooled state fixedly surrounds the chambers resp. the cartridge.

In order to provide advantageous residual emptying properties for the chambers, the bottom of the chambers can be inclined in a funnel shape toward the delivery opening. Moreover, the inner wall of a chamber can be embodied, by suitable material selection and/or surface configuration, in such a way that little material adhesion of the preparation onto the internal chamber wall occurs. This action, too, allows the residual emptying capability of a chamber to be further optimized.

The chambers of a cartridge can have volumetric capacities that are identical or differ from one another. In a configuration having two chambers, the ratio of the chamber volumes is equal to preferably 5:1, in a configuration having three chambers preferably 5:1:1, these configurations being suitable in particular for use in automatic dishwashers.

The cartridge usually has a volumetric capacity of <5000 ml, in particular <2000 ml, by preference between 10 and 1500 ml, preferably between 50 and 900 ml, and in particular between 250 and 800 ml.

The cartridge can assume any desired three-dimensional shape. It can for example be cubic, spherical or plate-like in configuration.

Commercially available household automatic dishwashers are usually designed so that provision is made to arrange larger items to be washed, for instance pans or large plates, in the lower rack of the automatic dishwasher. In order to prevent the user from positioning the dispensing system less than optimally in the upper rack, in an advantageous embodiment of the invention the dispensing system is dimensioned so as to enable the dispensing system to be positioned only in the receptacles of the lower rack provided therefor. To this end, the width and height of the dispensing system can be selected to be, in particular, between 150 mm and 300 mm, particularly preferably between 175 mm and 250 mm.

It is also conceivable, however, to embody the dispensing unit in a cup shape, with a substantially circular or square base outline.

### Dispenser

The control unit necessary for operation, a sensor unit, and at least one actuator are integrated into the dispenser. Preferably an energy source is likewise arranged in the dispenser.

The dispenser is preferably made up of a water-spray-protected housing that can prevent the penetration into the interior of the dispenser of sprayed water, as can occur, for example, for use in an automatic dishwasher.

It is particularly preferred that the dispenser encompass at least one first interface that interacts corresponding interface embodied in or on a water-conveying appliance, in particular a water-conveying household appliance, preferably an automatic dishwasher or washing machine, in such a way that a transfer of electrical energy from the water-conveying appliance to the dispenser is effected.

In an embodiment of the invention, the interfaces are embodied by plug connectors. In a further embodiment, the interfaces can be embodied in such a way that a wireless transfer of electrical energy is brought about.

In an advantageous refinement of the invention, a second interface is embodied respectively on the dispenser and on the water-conveying appliance, for example an automatic dishwasher, for the transfer of electromagnetic signals that represent in particular operating-state, measurement, and/or control information of the dispenser and/or of the water-conveying appliance such as an automatic dishwasher.

### Adapter

Simple coupling of the dispensing system to a water-conveying household appliance can be achieved by means of an adapter. The adapter serves for mechanical and/or electrical connection of the dispensing system to the water-conveying household appliance.

The adapter is connected, preferably fixedly, to a water-conveying line of the household appliance. It is also conceivable, however, to provide the adapter for a position, in or on the household appliance, in which the adapter is contacted by the water flow and/or spray stream of the household appliance.

The adapter makes it possible to configure a dispensing system in both an autonomous and a built-in version. It is also possible to embody the adapter as a kind of charging station for the dispensing system, in which e.g. the energy source of the dispenser is charged or data are exchanged between the dispenser and the adapter.

The adapter can be arranged in an automatic dishwasher on one of the inner walls of the washing chamber, in particular on the inner side of the dishwasher door. It is also conceivable, however, for the adapter as such to be positioned in the water-conveying household appliance in a manner not accessible to the user, so that the dispenser is, for example, inserted into the adapter during assembly with the household appliance, such that the adapter, the dispenser, and the household appliance are embodied in such a way that a cartridge can be coupled by the user to the dispenser.

As stated previously, the cleaning-agent presentation forms according to the present invention are notable for particular physical and chemical stability, in particular with respect to temperature fluctuations. The cleaning-agent presentation forms according to the present invention are thus exceptionally suitable for dispensing by means of a dispensing system located in the interior of an automatic dishwasher. A dispensing system of this kind, which can be integrated immovably into the interior of the automatic dishwasher (appliance-integrated dispenser) but can also, of course, be introduced into the interior as a movable apparatus (autonomous dispenser), contains several times the quantity of cleaning agent necessary for carrying out an automatic cleaning method.

“Movable” means, for purposes of this Application, that the delivery and dispensing system is not connected nondetachably to an apparatus such as, for example, an automatic dishwasher, washing machine, laundry dryer, or the like, but is, for example, removable from or positionable in an automatic dishwasher.

In summary, both the cleaning-agent combinations according to the present invention and the cleaning-agent presentation forms according to the present invention are suitable as refill packages for dispensers integrated immovably into the interior of an automatic dishwasher, and also for movable dispensers provided for positioning in the interior of an automatic dishwasher.

The use of a cleaning-agent presentation form according to the present invention as a cleaning-agent reservoir for
i) a dispenser integrated immovably into the interior of an automatic dishwasher, or
ii) a movable dispenser provided for positioning in the interior of an automatic dishwasher
   is likewise a subject of this Application.

Also a subject of this Application is the use of a cleaning-agent presentation form according to the present invention as a cleaning-agent reservoir for
i) a dispenser integrated immovably into the interior of a textile washing machine, or
ii) a movable dispenser provided for positioning in the interior of a textile washing machine.

The use of a cleaning-agent dispensing system according to the present invention as a cleaning-agent reservoir for an automatic dishwasher or textile washing machine is a further subject of the present Application.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. An automatic dishwashing method using a bleaching-agent-free cleaning-agent comprising
a) a liquid cleaning-agent preparation A having a pH (10% solution in H₂O; 20° C.) above 8.0, containing at least one builder;
b) a liquid cleaning-agent preparation B containing at least one enzyme preparation;
c) a liquid cleaning-agent preparation C containing at least one nonionic surfactant and/or one acid,
the cleaning-agent preparations A, B, and C being dispensed into an interior of an automatic dishwasher, in the course of the dishwashing method, from a cartridge located preferably in the interior of the automatic dishwasher, wherein
i) a sub-quantity a of the cleaning-agent preparation A located in the cartridge is dispensed into the interior of the automatic dishwasher, a residual quantity of the cleaning-agent preparation A located in the cartridge remaining in the cartridge until the end of the dishwashing method, and said residual quantity corresponding to at least twice the quantity of sub-quantity a; and
ii) a sub-quantity b of the cleaning-agent preparation B located in the cartridge is dispensed into the interior of the automatic dishwasher, a residual quantity of the cleaning-agent preparation B located in the cartridge remaining in the cartridge until the end of the dishwashing method, and said residual quantity corresponding to at least twice the quantity of sub-quantity b; and
iii) a sub-quantity c of the cleaning-agent preparation C located in the cartridge is dispensed into the interior of the automatic dishwasher, a residual quantity of the cleaning-agent preparation C located in the cartridge remaining in the cartridge until the end of the dishwashing method, and said residual quantity corresponding to at least twice the quantity of sub-quantity c.

2. An automatic textile washing method using a bleaching-agent-free cleaning-agent comprising
a) a liquid cleaning-agent preparation A having a pH (10% solution in H₂O; 20° C.) above 8.0, containing at least one builder;
b) a liquid cleaning-agent preparation B containing at least one enzyme preparation;
c) a liquid cleaning-agent preparation C containing at least one compound selected from textile conditioning agents, defoamers, complexing agents, and perfume substances,
the cleaning-agent preparations A, B, and C being dispensed into an interior of a textile washing machine, in the course of the textile washing method, from a cartridge located preferably in the interior of the textile washing machine, wherein
i) a sub-quantity a of the cleaning-agent preparation A located in the cartridge is dispensed into the interior of the textile washing machine, a residual quantity of the cleaning-agent preparation A located in the cartridge remaining in the cartridge until the end of the textile washing method, and said residual quantity corresponding to at least twice the quantity of sub-quantity a; and
ii) a sub-quantity b of the cleaning-agent preparation B located in the cartridge is dispensed into the interior of the textile washing machine, a residual quantity of the cleaning-agent preparation B located in the cartridge remaining in the cartridge until the end of the textile washing method, and said residual quantity corresponding to at least twice the quantity of sub-quantity b;
iii) a sub-quantity c of the cleaning-agent preparation C located in the cartridge is dispensed into the interior of the textile washing machine, a residual quantity of the cleaning-agent preparation C located in the cartridge remaining in the cartridge until the end of the textile washing method, and said residual quantity corresponding to at least twice the quantity of sub-quantity c.

3. The automatic dishwashing method or automatic textile washing method according to claim 1, wherein the cleaning-agent presentation form A contains a complexing agent.

4. The automatic dishwashing method or automatic textile washing method according to claim 1, wherein the cleaning-agent preparation B contains at least one enzyme preparation selected from the group consisting of amylase preparations, protease preparations, and lipase preparations, and wherein the weight proportion of the enzyme preparation(s) in terms of the total weight of the cleaning-agent preparation B is from 10 to 60 wt %.

5. The automatic dishwashing method according to claim 1, wherein the cleaning-agent preparation C contains, based on the total weight of the cleaning-agent preparation C, nonionic surfactant in quantities from 1.0 to 18 wt %.

6. The automatic dishwashing method according to claim 1, wherein the cleaning-agent preparation C contains at least one acid selected from the group consisting of organic acids, and wherein the weight proportion of the acid in terms of the total weight of the cleaning-agent preparation C is from 0.1 to 12 wt %.

7. The automatic textile washing method according to claim 2, wherein the cleaning-agent preparation C contains at least one compound selected from the group consisting of textile conditioning agents, defoamers, complexing agents, and perfume substances.

8. The automatic dishwashing method according to claim 1, wherein at least one of the cleaning-agent preparations A, B, or C comprises a solubilizer, and wherein the weight proportion of the solubilizer in terms of the total weight of the cleaning-agent preparation C is from 1.0 to 18 wt %.

9. The automatic dishwashing method according to claim 1, wherein the cleaning-agent preparations A, B, and C are present separately from one another in one common cartridge.

10. The automatic dishwashing method according to claim 1, wherein the cleaning-agent preparations A, B, and C are dispensed into the interior of the automatic dishwasher at different times in the course of the dishwashing method.

11. A cleaning-agent comprising
a. a liquid cleaning-agent preparation A having a pH (10% solution in H₂O; 20° C.) above 8.0, containing at least one builder;
b. a liquid cleaning-agent preparation B containing at least one enzyme preparation;
c. a liquid cleaning-agent preparation C containing at least one nonionic surfactant and/or one acid,
wherein the cleaning-agent preparations A, B, and C are present separately from one another in one common cartridge.

12. A cleaning-agent presentation form comprising
a. a liquid cleaning-agent preparation A having a pH (10% solution in H₂O; 20° C.) above 8.0, containing at least one builder;
b. a liquid cleaning-agent preparation B containing at least one enzyme preparation;
c. a liquid cleaning-agent preparation C containing at least one compound selected from textile conditioning agents, defoamers, complexing agents, and perfume substances,
wherein the cleaning-agent preparations A, B, and C are present separately from one another in one common cartridge.
